(19) United States
(12) Patent Application Publication
(10) Pub. No.: US 2014/0374012 A1
(43) Pub. Date: Dec. 25, 2014

(54) DEVICE FOR THE MANUFACTURE OF A BONDED COMPONENT WITH FIBRE-REINFORCED PLASTICS AND ALSO A METHOD

(71) Applicant: Heinz Bardenhagen, Stade (DE)

(72) Inventor: Heinz Bardenhagen, Stade (DE)

(21) Appl. No.: 14/234,628

(22) PCT Filed: Jul. 27, 2012
(86) PCT No.: PCT/EP2012/064815

§ 371 Date: May 6, 2014

Related U.S. Application Data
(60) Provisional application No. 61/512,001, filed on Jul. 27, 2011.

(30) Foreign Application Priority Data
Jul. 27, 2011 (DE) 10 2011 079 928.1

(51) Int. Cl. B32B 37/10; B32B 37/00

(52) U.S. Cl. CPC B32B 37/1018; B32B 37/0046
USPC 156/242; 156/381

(57) ABSTRACT

A device and method for manufacturing a bonded component with fiber-reinforced plastics with a base molding tool and a molding tool. The adhesive component is arranged between the base molding tool and the molding tool. The bonded component has a base laminate and a reinforcement laminate. The molding tool is covered with an aeration material and a vacuum envelope. The vacuum envelope is sealed with respect to the base molding tool. The molding tool is at least partially formed from a metal alloy, which has an anomalous thermal expansion coefficient. Undesirable lost cavities in the device are reduced to minimize reductions in thickness in the end face or longitudinal face regions of the cured bonded component. A seal can additionally be provided, as can at least one molding tool free of projections, and also an aeration material arranged on the at least one molding tool in only some regions.

### CROSS-REFERENCES TO RELATED APPLICATIONS

This application claims the benefit of the U.S. Provisional Application No. 61/512,001, filed on Jul. 27, 2011, and of the German patent application No. 10 2011 079 928.1 filed on Jul. 27, 2011, the entire disclosures of which are incorporated herein by way of reference.

### BACKGROUND OF THE INVENTION

The invention concerns a device for the manufacture of a bonded component with fiber-reinforced plastics with at least one base molding tool and at least one molding tool, wherein the bonded component is arranged between the base molding tool and the molding tool and the bonded component has at least one base laminate and at least one reinforcement laminate, and the molding tool is covered with an aeration material and with a vacuum envelope, wherein the vacuum envelope is sealed with respect to the base molding tool.

For components in which high strengths and stiffnesses are required per unit weight, as, for example, in aerospace applications, fiber-reinforced plastics (FRPs) are often deployed. A fiber-reinforced plastic is a material that is formed with a multiplicity of reinforcing fibers that are embedded in a plastic matrix material. At the present time carbon fibers, glass fibers, Aramide® fibers, natural fibers, or similar, are, among others, deployed as the reinforcing fibers. As a rule the matrix material consists of thermosetting plastics, such as, for example, epoxy resins, polyester resins, phenol resins, or bismaleimide resins (so-called BMI resins). The bonded components can be manufactured with reinforcing fibers that are already pre-impregnated with matrix material (so-called prepreg material, prepreg semi-finished products), and/or with reinforcing fibers, i.e., fiber products, with a suitable geometry, which are only infiltrated, i.e., impregnated, with the matrix material immediately before the curing process. Complex, integral fiber-reinforced plastic structures usually consist of at least one base laminate with a multiplicity of reinforcing and connecting components. These elements can be available as fiber-reinforced plastic components that have already been consolidated, as components of other materials, and also as fiber-reinforced plastic laminates. Fiber-reinforced plastic laminates consist of two or more layers of reinforcing fibers that have been pre-impregnated with a matrix material, and which are not yet cured. The reinforcing fibers can be available as a unidirectional layer, a woven fabric, a knitted fabric, or a multi-layer mat. The layers usually have differing primary fiber directions with a course that is preferably aligned with the forces that are occurring.

One variant for the design of components from fiber-reinforced plastics is, for example, a large-format shell with longitudinal stiffeners, in particular I-stringers, or stringers with cross-sectional geometries that differ from the latter, in an integral form of construction. These are constructed from at least one base laminate and reinforcement laminates, such as, for example, stringer laminates, and also from partial reinforcements and other features as required.

Shells stiffened with I-stringers in an integral form of construction are components that are often spherically curved. Through the design of the base laminate, the use of reinforcements and insulation material, and also the addition of other elements, components of complex shape ensue, with very different thicknesses and contours in some sections. Such shell components find application, for example, in the manufacture of lifting surfaces, ailerons, landing flaps, elevator units, vertical tail units, fuselage shells, or similar items for the production of aircraft.

For the manufacture of a shell component with integral reinforcing elements, such as, for example, stringers, the stringer laminates are laid down in accordance with a procedure of known prior art—here cited in an exemplary manner—on molding tools fitted with means of release, and are shaped on the latter. In a further operation a base laminate is laid down on a base molding tool similarly fitted with means of release, and is aligned on the latter. The molding tools are then brought together, spatially aligned, and as a unit are together laid down on the base laminate. The whole arrangement is then fitted with a vacuum generation system and the device thus created is introduced into an autoclave for purposes of full curing at high pressure and temperature. The removal of the bonded component from the device represents the final production step. Parasitic voids represent a major difficulty in the production of integrally reinforced shells; these are already present within the device, or occur only during the curing process. In particular matrix material can penetrate into these voids; in turn this leads to a reduction of the material thickness of the bonded component. Bonded components, whose material thickness is significantly less than a tightly prescribed value less a tolerance that is a rule is small, must in general undergo complex further treatment, which leads to significant extra costs.

A multiplicity of effects are responsible for the occurrence or existence of such lost spaces. Thus, during the curing process the cavity formed by the molding tools and the overlying vacuum generation system is filled with the fiber-reinforced plastic that has been introduced, in particular with its matrix material. In addition to the form-defining cavity that is required for the design of the bonded component, further undesirable cavities are present. These voids ensue as a result of gaps and/or capillaries between the individual molding tools, among other factors. In addition, empty spaces ensue as a result of volumes underneath the molding tools that are not filled, as caused by deviations of size and/or location of the laminates, deviations of size and/or location of the molding tools, and also the thermal expansion of the molding tools during the heating process in the autoclave in the course of the curing process. In the event of a temperature variation of, for example, 160° C. a molding tool made of a conventional aluminium alloy and with a length of 4000 mm, experiences, for example, an expansion of approx. 15 mm. Furthermore undesirable voids can also form within the vacuum generation system, for example as a result of a vacuum envelope that is not fully fitted, or as a consequence of the very bulky aeration material.

From the prior art Invar alloys for molding tools and base molding tools in a wide range of variants are of known art. The “Invar” designation is generally understood to mean an iron-nickel alloy with a content of 36% nickel (FeNi36/1.3912).

DE 10 2008 036 349 A1 concerns a method and also a device for the manufacture of a structure, in particular an aircraft structure, from a fiber-reinforced plastic, wherein in the device those sections of the component remain free of aeration material and/or tear-off material, in which steps or discontinuities are located. In addition the document does not show any molding tools for purposes of defining the form of reinforcement laminates. Moreover the method starts from reinforcing elements that are at least partially cured, and/or from light metal reinforcements. Accordingly the formation of undesirable voids in the later fiber-reinforced composite component cannot be reduced to the required extent by means of the technical teaching disclosed in DE 10 2008 036 349 A1.

### SUMMARY OF THE INVENTION

The object of the invention in the first instance is to create a device for the manufacture of components with fiber-reinforced plastics, in which lost cavities either do not any longer occur at all, or only to a very limited extent, so that in particular intolerable reductions in thickness are avoided and what is as a rule complex further treatment for purposes of thickening the components in some regions is omitted. Furthermore it is an object of the invention to specify a method for the manufacture of such components.

In that at least one molding tool is formed at least partially with a metal alloy that has an anomalous thermal expansion coefficient, temperature-conditioned expansions of the length of the molding tools are in particular reduced during the curing process of the bonded component in the autoclave, so that the molding tools no longer project beyond the bonded component as a result of thermal expansion, and thus undesirable lost cavities are to a large extent avoided. Both the at least one base laminate and also the reinforcement laminates are preferably formed from fiber-reinforced plastic, such as, for example, a prepreg material. The reinforcement and base laminates located within the device are only cured after the introduction of the device into an autoclave with the application of pressure and temperature to form a bonded component.

In accordance with an advantageous development of the device provision is made that the metal alloy is in particular FeNi 36/1.3912.

This Invar metal alloy, which finds many applications in engineering, has an anomalous thermal expansion coefficient, so that with the high temperatures prevailing in the autoclave the molding tools that are made from this alloy are only subjected to a low level of thermal expansion. Alternatively other metal alloys that have a comparable anomalous thermal expansion coefficient can be deployed for the inventive device.

The alloy Fe65Ni35-Invar has the following physical properties, among others: a thermal expansion coefficient between 20° C. and 90° C. of approximately 1.7-2.0.10-6 1/K, a thermal conductivity at 23° C. of approximately 13 Wm-1K−1, a specific electrical resistance of approximately 75-85 μΩ·cm, a density of approximately 8 g/cm3 and a tensile strength of approximately 450-590 N/mm2.

In an advantageous further development of the invention a seal is fitted in at least some sections of a peripheral contour in a gap-free manner, in particular on at least one end face and/or at least one longitudinal face of the bonded component. By this means, among others, matrix material and, under some circumstances, reinforcing fibers are prevented from being flushed out of the bonded component during the autoclave process and/or from penetrating into any lost cavities still present within the device. In addition the seal, by virtue of its elasticity, allows for the compensation of deviations in size and/or location of the at least one base laminate and also of the reinforcement laminates of the bonded component. The peripheral contour of what is, for example, a rectangular bonded component is formed by the two opposing shorter end faces and the longitudinal faces running at right angles to the latter, which are significantly longer than the end faces. In accordance with a further advantageous configuration of the device provision is made that the seal is formed from an elastic material, in particular from a mixture of rubber and cork.

As a consequence of this material composition a high temperature resistance is provided with adequate elasticity and nevertheless a sufficient mechanical load capacity for the seal. Here the cork-rubber mixture is held together by means of a suitable binding agent.

In accordance with a further development of the device the seal is provided on at least one side in at least some sections with an adhesive layer.

By virtue of the adhesive layer the seal is thus reliably secured against slippage in its location at the respective position on the base molding tool.

In a further advantageous configuration of the invention at least one end face and/or at least one longitudinal face of the at least one molding tool ends flush with the seal in at least some sections. As a consequence of this configuration of the molding tools, free of projections or overhangs relative to the bonded component, with a seal fitted, the lost cavities that otherwise exist between the molding tool overhangs and the base molding tool, are to a large extent eliminated.

In accordance with a further configuration of the device the aeration material covers the at least one molding tool and/or the base molding tool in at least some regions.

By this means the number of lost cavities in the vacuum generation system can in particular be further reduced if regions with small radii of curvature remain free of aeration material. The aeration material is preferably formed with a polyester fleece or a polyester weave that is permeable to air.

In a further configuration of the invention provision is made that at least one corner region, in particular between an upper face of the base molding tool and at least one end face and/or one longitudinal face of the at least one molding tool, is free of aeration material.

By this means the formation of lost cavities in these zones is reduced, because the relatively inflexible and bulky (stiff) aeration material in these regions in many cases is unable to lie on the tools without forming a gusset, i.e., it can only cling to the latter while forming small voids. Alternatively the aeration material can also be designed to be fully continuous.

In the course of the inventive method at least one base laminate is placed and aligned on the base molding tool in the first instance. Fiber-reinforced plastics, in particular prepreg materials, are preferably deployed as base laminates and as reinforcement laminates. On the periphery, i.e., along the end faces and also the longitudinal faces of the base laminate of the bonded component, a seal is then fitted in a gap-free manner, as least on some sections. Reinforcement laminates are next shaped onto the molding tools. The molding tools are then assembled into a group with the reinforcement laminates that are located on them, and are placed as a unit on the base laminate. The molding tools can then be provided with an optionally perforated release layer, which for its part is overlaid in at least some regions with an aeration material, which together with the vacuum envelope that is yet to be fitted represents the vacuum generation system of the device. Here corner regions between the molding tools and the base molding tool are in particular not overlaid with the aeration material, i.e., the aeration material has openings in these zones in order to reduce lost cavities in these sections. In addition further functional layers, such as, for example, release layers, tear-off layers, or resin removal layers, can be provided on the base molding tool and/or on the molding tools, in at least some sections, and also on and/or underneath the aeration material. The whole system is then covered with a vacuum envelope to complete the device. The vacuum envelope can be subjected to reduced pressure to achieve a partial vacuum via at least one vacuum channel with at least one perforated covering accommodated therein. For purposes of curing the adhesive component formed from the at least one base laminate and the at least one reinforcement laminate by the application of pressure and/or temperature the whole device is placed in an autoclave. After the curing process is completed the device can be taken out of the autoclave, and the bonded component, cured to form a finished component, in particular an integrally reinforced shell, can be extracted. In the course of the curing process the device remains in the autoclave.

### BRIEF DESCRIPTION OF THE DRAWINGS

In the drawing:

FIG. 1 shows a cross-sectional representation through an arrangement of known prior art for the production of fiber-reinforced plastic components.

FIG. 2 shows a longitudinal section through the arrangement of FIG. 1 along the section line II-II,

FIG. 3 shows a longitudinal section through an inventive device with molding tools made from a metal alloy with an anomalous thermal expansion coefficient,

FIG. 4 shows the device in accordance with FIG. 3 with an optional seal,

FIG. 5 shows a magnified representation of part of the device from FIG. 4, but with molding tools optionally embodied free of projections, and

FIG. 6 shows the device in accordance with FIG. 3, but with aeration material partially provided,

In the drawings the same design elements have the same reference numbers in each case.

### DETAILED DESCRIPTION OF THE PREFERRED EMBODIMENTS

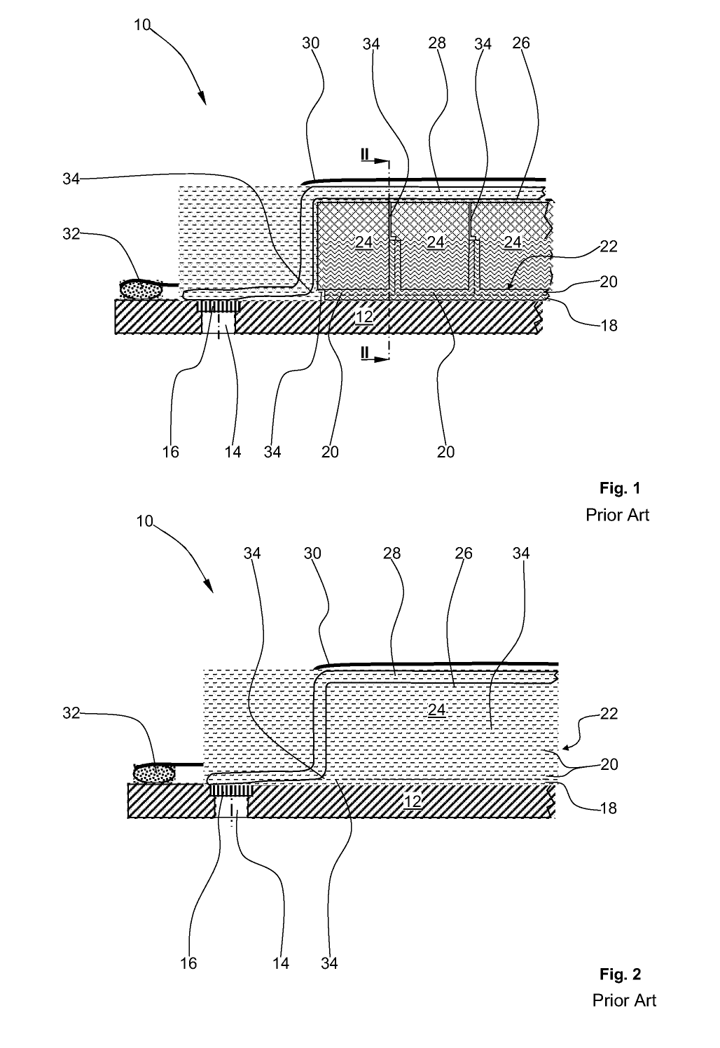

FIG. 1 shows a schematic cross-section through an arrangement of known prior art for the manufacture of components from fiber-reinforced plastics, while FIG. 2—to which reference is made at the same time—illustrates a simplified longitudinal section through the arrangement in accordance with the section line II-II in FIG. 1.

The arrangement 10 comprises, among other items, a base molding tool 12 with a vacuum channel 14, into which is inserted a perforated covering 16. On the base molding tool 12 is located a base laminate 18, on which three reinforcement laminates 20 are laid down; together these form the bonded component 22, and after this has been cured in the autoclave, embody the prefabricated component that is to be manufactured, such as, for example, an integrally reinforced shell, or similar. The spatial geometry of the reinforcement laminates 20 is here defined by means of three molding tools 24, i.e., cores. On the molding tools 24 runs a release layer 26, which for its part is covered with an aeration material 28. The aeration material 28 is covered with a vacuum envelope 30, wherein a seal 32 is arranged between the vacuum envelope 30 and the base molding tool 12, so that a gas-tight closure of the vacuum generation system thus formed is achieved relative to the external environment. The at least one base laminate 18 and the reinforcement laminates 20 are formed from a fiber-reinforced plastic. In aerospace a prepreg material made up from an epoxy resin reinforced with fibers, i.e., fiber rovings, often finds application as the fiber-reinforced plastic (FRP). Within the device 10 a multiplicity of undesirable voids 34 form, in particular during the curing process of the bonded component 22—in which the whole arrangement 10 is placed in an autoclave, and a reduced pressure prevails within the vacuum envelope 30 for at least some of the time. As can be seen from FIGS. 1, 2 the voids 34 exist between each of the molding tools 24, and a further void 34 in the form of a gusset is located underneath the aeration material 28 within the vacuum generation system. The other voids 34 are to be attributed to, among other factors, thermal expansion effects of the molding tools 24 and/or of the base molding tool 12 in the course of the curing process in the autoclave. Matrix material can flow into the voids 34, as a result of which a material thickness of the bonded component 22 can be reduced to the extent that this, less the prescribed tolerance, lies below a prescribed limiting value, and complex rework is required in order to bring the bonded component 22 up to the required minimum design thickness.

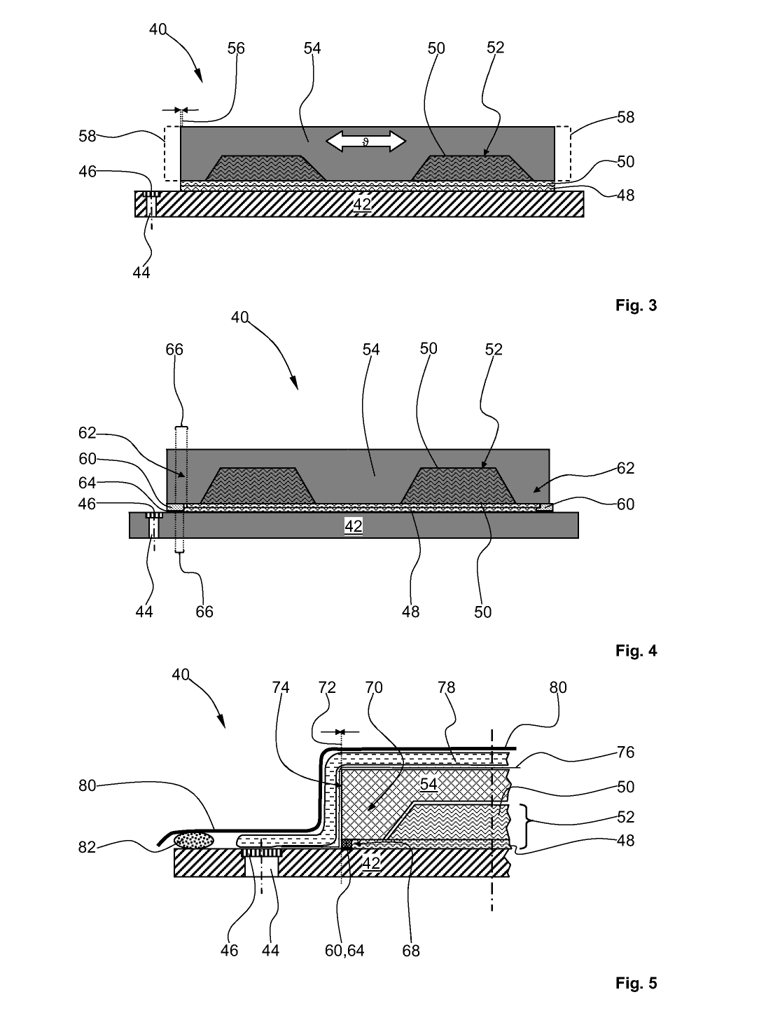

FIG. 3 shows a simplified representation of a device in accordance with the invention. In the interests of improving the clarity of the drawing the vacuum generation system is not represented. The device 40 comprises, among other items, a base molding tool 42 with an integrated vacuum channel 44 and a perforated covering 46 arranged in the latter. A reduced pressure, i.e., a partial vacuum, can be built up in the vacuum generation system, not represented here, via the vacuum channel 44. On the base molding tool 42 are laid down a base laminate 48 and a reinforcement laminate 50; together these form the bonded component 52, which, after completion of the curing process in the autoclave, represents the finished bonded component, i.e., the prefabricated component, such as, for example, an integrally reinforced shell made of fiber-reinforced plastics, or similar. The bonded component 52 is accommodated between the base molding tool 42 and at least one (upper) molding tool 54. The base molding tool 42 forms together with the molding tool 54 a so-called “bonded component cavity”, which serves the purpose of molding, i.e., defining the form, of the initially still soft, i.e., not yet cured, bonded component 52. In accordance with one aspect of the invention the at least one molding tool 54 is formed from a metal alloy, which—as indicated by the horizontal white double arrow—has an anomalous, i.e., very small, thermal expansion coefficient as the temperature fluctuates. The at least one molding tool 54 is preferably formed from a metal alloy with the composition FeNi 36/1.3912 (Invar). Alternatively the molding tool 54 can be formed from a preferred thermo-setting plastic material, if this has a sufficiently small thermal expansion coefficient, the necessary temperature resistance, and a sufficient mechanical load capacity. By virtue of the negligibly small thermal expansion 56 of the molding tool 54 manufactured from the Invar metal alloy, any increasing projection of the bonded component 52 as a result of thermally-conditioned molding tool overhangs 58, primarily as a consequence of the expansion of the molding tool 54 during the heating phase of the curing process, is significantly reduced.

FIG. 4 illustrates the device in accordance with FIG. 3, but with an additional peripheral seal.

The device 40 comprises in turn the base molding tool 43 and the molding tool 54 for purposes of creating the form-defining cavity for the bonded component 52. The base molding tool 42 is fitted with the vacuum channel 44 and with the perforated covering 46 to allow the connection of a vacuum pump. In contrast to FIG. 3 the device 40 is here provided with an optional, preferably peripheral, seal 60. The upper molding tool 54 is preferably manufactured from a metal alloy with a low thermal expansion coefficient, such as Invar, for example. The seal 60 is arranged between the molding tool overhangs 62, here taken into account in the design, and the base molding tool 42, and is preferably fitted in a gap-free manner on at least one end face 68 and/or at least one longitudinal face of the bonded component 53, at least on some sections. The seal is preferably provided on those sections of the end faces and/or longitudinal faces of the bonded component in which the largest reductions in thickness are to be anticipated as a result of undesirable flows of the matrix material out of the bonded component 52 into lost cavities during the autoclave process.

In the example of embodiment shown in FIG. 4 the seal 60 is additionally provided on its lower face with a thin adhesive layer 64 for purposes of securing its location on the base molding tool 42. The seal 60 is preferably manufactured from a mixture of cork and rubber, together with a binding agent, which has a sufficient elasticity and thermal load-bearing capability. For this purpose suitable mixing proportions of the cork, rubber and the binding agent are to be produced.

By means of the seal 60 in the region of the peripheral contour (end faces/longitudinal faces) of the bonded component 52 in the first instance any possible transfer of matrix material into the vacuum generation system, i.e., into the voids formed by the vacuum generation system, is reduced. In addition the seal 60 reduces voids in the region of the bonded component 52, which arise in particular as a result of deviations of location and/or dimension of the base and reinforcement laminates 48, 50 and also of the at least one molding tool 54. The seal 60 is preferably attached to the base laminate 48 in a gap-free manner after the base laminate 48 has been laid down on the base molding tool 42. The at least one molding tool 54, together with the reinforcement laminate 50 that is shaped on the latter, is then introduced, and aligned and laid down on the base laminate 48. The reinforcement laminate 50, supported on the seal 60, in at least some regions as required, does not lead to any conflict, because the elastic seal 60 is compressed and/or displaced by the reinforcement laminate 50.

FIG. 5 shows a magnified representation of part of the device in accordance with FIG. 4, wherein in contrast to the latter the molding tool is free of projections (including seal) and a simplified vacuum generation system is also represented. The device 40 comprises the base molding tool 44 with the vacuum channel 44 located therein, and the perforated covering 46 accommodated in the vacuum channel. The bonded component 52 located between the molding tool 54 comprises the base laminate 48 and the reinforcement laminate 50. The optional seal 60 with the adhesive layer 64 here arranged on the lower face of the latter is arranged in the example of embodiment shown in FIG. 5 at least on some sections along at least one end face 68 of the bonded component 52, i.e., of the base laminate 48 and the reinforcement laminate 50. Additionally or alternatively the seal 60 can also be provided in the region of the end face, not represented here, opposing the end face 68, and/or of at least one longitudinal face, likewise not marked, of the bonded component 52. The seal 60 preferably surrounds the peripheral contour (end faces/longitudinal faces) of the bonded component 52 completely and is moreover designed to be continuous, i.e., free of openings. The molding tool 54 is preferably formed from Invar.

In contrast to the form of embodiment in accordance with FIG. 4 an end section 70 of the molding tool 54 is designed free of projections, i.e., overhangs, in relation to the bonded component 52 including the seal 60, that is to say a horizontal separation distance 72 between the seal 60 and a molding tool end face 74 is here approximately zero, so that the molding tool end face 74 ends essentially flush with the seal 60. A further end section of the molding tool 54, not represented here, located opposite to the end section 70 of the molding tool 54, is preferably designed in a corresponding manner to the end section 70 of the molding tool 54. The same is true for at least one longitudinal face of the at least one molding tool 54.

A vacuum generation system, not provided with a reference number, of the device 40, is formed with, among other items, a release layer 76, which rests on the molding tool 54 and the base molding tool 42. The release layer for its part is covered with an aeration material 78, which in turn is overlaid with a vacuum envelope 80. In addition to the release layer 76 and the aeration material 78 further functional layers, such as, for example, tear-off layers and/or resin removal layers, can be provided in the vacuum generation system. By means of the seal 82 the vacuum envelope 80 forms a hermetically sealed space. In this manner a reduced pressure, i.e., a partial vacuum, can be generated underneath the vacuum envelope 80 via the vacuum channel 44. By virtue of the configuration of the end section 70 of the molding tool 54 here shown, which is free of projections, i.e., overhangs, the molding tool 54 no longer projects over the end face 68 of the bonded component 52—including the seal 60—so that fewer undesirable lost cavities can form.

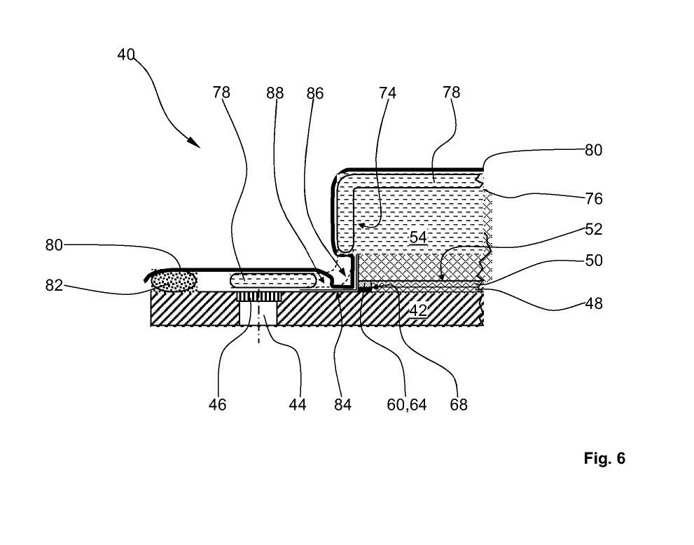

FIG. 6 shows a scrap section of the device in accordance with FIG. 5, but with aeration material that is only partially provided. The device 40 comprises the base molding tool 42 and the molding tool 54 with the bonded component 52 accommodated in between; the latter is in turn built up from the at least one base laminate 48 and at least one reinforcement laminate 50. The seal 60 is fitted on the end face 68 of the bonded component 52, ideally in a gap-free manner. The vacuum channel 44 and the perforated covering 46 are integrated into the base molding tool 42. The molding tool 54, together with an upper face 84 of the base molding tool 42, are overlaid with the optional release layer 76.

In contrast to the form of embodiment in FIG. 5 the release layer 76 is only overlaid with the aeration material 78 is some regions. As a rule the aeration material 78 takes the form of a relatively stiff surface textile weave, in particular a polyester fleece and/or a polyester weave. The largely inflexible, very thick aeration material 78 is unable to lie close to zones of the device 40 with only small radii of curvature (so-called discontinuities, steps, levels), so that multiple undesirable gusset-type cavities form underneath the vacuum envelope 80.

For purposes of avoiding this effect a corner region 86 between the vertical end face 74 of the molding tool 54, i.e., of the seal 60, and the horizontal upper face 84 of the base molding tool 42 is not overlaid with the aeration material 74, i.e., the aeration material 78 has a cut-out 88 in the corner region 86. By this means the occurrence of undesirable cavities in the vacuum generation system underneath the vacuum envelope 80, i.e., the release layer 76, in the corner region 86 is in particular reduced; these otherwise form easily by virtue of the stiff, inflexible aeration material 78 in these regions, as a result of folds or waves in the aeration material 78. In addition the risk of any matrix material flowing out of the bonded component 52—during the curing process in the autoclave—into these lost cavities, notwithstanding the presence of the seal 60, is further minimised. This in turn has the consequence that undesirable reductions of the thickness of the bonded component 52, in particular in the region of the end face 68, are avoided.

In a variation from the relief of the corner region 86, here just shown in an exemplary manner, the overlay of other regions of the molding tool 54 and/or the base molding tool 42 with the aeration material 78 can also be eliminated as required. Thus the partial removal of the aeration material 78 in the corner region 86 reduces any possible losses of matrix material of the bonded component 52 due to the avoidance of voids into which matrix material from the bonded component 52 can infiltrate as a result of a fall in pressure. The cut-out 88 is to be dimensioned with regard to its size and position such that a proper evacuation of the vacuum generation system is ensured. The aeration material 78 is itself usually covered in turn with the vacuum envelope 80 and by means of the seal 82 is sealed with respect to the base molding tool 42. A reduced pressure, i.e., a partial vacuum, can be built up and maintained underneath the vacuum envelope 80 via the vacuum channel 44 by means of a vacuum pump. The aeration material 78 can be manufactured, for example, with a continuous (one-piece) surface textile weave, into which cut-outs can preferably be introduced so as to come to lie in the corner regions. Alternatively a plurality of sections or strips of the aeration material 78, spaced apart from one another, can be positioned onto the release layer 76, or the upper face 84 of the base molding tool 42, so as to create the cut-out 88.

Compared with arrangements of prior known art for the production of such bonded components, undesirable cavities are reduced and the reductions in laminate thickness of the bonded component that result from such cavities are minimised, as are the consequential rework costs. For the most effective possible minimisation of undesirable lost cavities the device 40 can comprise at least one of the above described provisions (cf. in particular FIGS. 3 to 6), namely at least one molding tool 54 with a low thermal expansion, at least one molding tool 54 free of projections, i.e., overhangs, a seal 60 arranged in at least some sections of the periphery of the bonded component, and also an aeration material 78 that is only applied in some regions. In conclusion the device 40 enables the manufacture, in a reliable process that is suitable for series production, of bonded components with fiber-reinforced plastics that are of high quality, dimensionally stable, and require no rework, such as, for example, integrally reinforced (shell) components that at the present time find widespread application in the manufacture of aircraft.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### REFERENCE SYMBOL LIST

10. Arrangement
12. Base molding tool
14. Vacuum channel
16. Perforated covering
18. Base laminate
20. Reinforcement laminate
22. Adhesive component
24. Molding tool
26. Release layer
28. Aeration material
30. Vacuum envelope
32. Seal
34. Void (undesirable)
40. Device
42. Base molding tool
44. Vacuum channel
46. Perforated covering
48. Base laminate
50. Reinforcement laminate
52. Adhesive component
54. Molding tool
56. Thermal expansion
58. Molding tool overhang (thermal)
60. Seal (peripheral)
62. Molding tool overhang (design)
64. Adhesive layer
66. Deviation in size and/or location
68. End face (bonded component)
70. End section (molding tool)
72. Separation distance
End face (molding tool)
76. Release layer
78. Aeration material
80. Vacuum envelope
82. Seal
84. Upper face
86. Corner region
88. Opening

1-9. (canceled)

10. A device for the manufacture of a bonded component with fiber-reinforced plastics comprising:
at least one base molding tool, and
at least one molding tool,
the bonded component being arranged between the base molding tool and the molding tool,
the bonded component having at least one base laminate and at least one reinforcement laminate,
the molding tool being covered with an aeration material and with a vacuum envelope,
the vacuum envelope being sealed with respect to the base molding tool, and
at least one molding tool being at least partially formed from a metal alloy, which has an anomalous thermal expansion coefficient.

11. The device in accordance with claim 10, wherein the metal alloy is in particular FeNi 36/1.3912.

12. The device in accordance with claim 10, wherein a seal is fitted in at least some sections of a peripheral contour in a gap-free manner.

13. The device in accordance with claim 12, wherein the seal is fitted on at least one of at least one end face and at least one longitudinal face of the bonded component.

14. The device in accordance with claim 12, wherein the seal is formed from an elastic material.

15. The device in accordance with claim 14, wherein the seal is formed from a mixture of rubber and cork.

16. The device in accordance with claim 12, wherein the seal is provided on at least one side in at least some sections with an adhesive layer.

17. The device in accordance with claim 10, wherein at least one of at least one end face and at least one longitudinal face of the at least one molding tool ends flush with the seal in at least some sections.

18. The device in accordance with claim 10, wherein the aeration material covers at least one of the at least one molding tool and the base molding tool in at least some regions.

19. The device in accordance with claim 18, wherein at least one corner region is free of aeration material.

20. The device in accordance with claim 19, wherein the corner region that is free of aeration material is located between an upper face of the base molding tool and at least one of at least one end face and one longitudinal face of the at least one molding tool.

21. A method for the manufacture of a bonded component with fiber-reinforced plastics using the device in accordance with claim 10.
